(19) United States
(12) Patent Application Publication
(10) Pub. No.: US 2016/0079596 A1
(43) Pub. Date: Mar. 17, 2016

(54) LITHIUM-ION SECONDARY BATTERY AND METHOD OF MANUFACTURING THE SAME

(71) Applicant: TOYOTA JIDOSHA KABUSHIKI KAISHA, Toyota-shi (JP)

(72) Inventor: Yoshitomo TAKEBAYASHI, Toyota-shi (JP)

(73) Assignee: TOYOTA JIDOSHA KABUSHIKI KAISHA, Toyota-shi (JP)

(21) Appl. No.: 14/851,475

(22) Filed: Sep. 11, 2015

(30) Foreign Application Priority Data
Sep. 12, 2014 (JP) 2014-186754

(51) Int. Cl. H01M 4/505; H01M 4/525; H01M 4/04; H01M 4/52; H01M 10/0525; H01M 4/36; H01M 4/58; H01M 4/50

(52) U.S. Cl. CPC H01M 4/505; H01M 4/5825; H01M 4/525; H01M 4/502; H01M 4/523; H01M 10/0525; H01M 4/366; H01M 4/0402; H01M 2004/028

(57) ABSTRACT

A lithium-ion secondary battery includes a positive electrode, a negative electrode and a non-aqueous electrolyte. The positive electrode includes a positive active material layer. The negative electrode includes a negative active material layer. The positive active material layer contains a positive active material and an inorganic phosphate compound. A BET specific surface area of the positive active material is 0.3 m²/g to 1.15 m²/g. The inorganic phosphate compound includes at least one of an alkali metal, an alkaline earth metal, and a hydrogen atom in a chemical formula. A content of the inorganic phosphate compound in the positive active material layer is 0.02 g/m² to 0.225 g/m² per unit surface area based on the BET specific surface area of the positive active material. The lithium-ion secondary battery allows an open-circuit voltage of the lithium-ion secondary battery to increase to 4.3 V or higher in terms of metal lithium.

### INCORPORATION BY REFERENCE

The disclosure of Japanese Patent Application No. 2014-186754 filed on Sep. 12, 2014 including the specification, drawings and abstract is incorporated herein by reference in its entirety.

### BACKGROUND OF THE INVENTION

1. Field of the Invention

The present invention relates to a lithium-ion secondary battery and a method of manufacturing the same.

2. Description of Related Art

In recent years, a lithium-ion secondary battery has been used to drive a motor of an electric vehicle, a hybrid electric vehicle, a fuel cell vehicle, or the like or as an auxiliary power source thereof. Therefore, there is a demand for a higher output and a long service life after a large number of cycles.

In order to achieve a high output, an increase in the voltage of a battery, that is, an increase in the upper limit voltage, during use is required. In order to achieve the increase in the voltage, for example, using a high-potential positive active material (typically a lithium transition metal compound) that can appropriately function as a positive active material even in a case of charge to a potential that is higher than the upper limit voltage of a general lithium-ion secondary battery in a typical use mode, as a positive electrode material has been considered. The potential higher than the upper limit voltage in a typical use mode may be regarded as a potential that is equal to or higher than 4.3 V (vs.Li/Li⁺) in association with a positive electrode potential.

However, in the lithium-ion secondary battery which realizes a high voltage of equal to or higher than 4.3 V (vs.Li/Li⁺) as an open-circuit voltage (OCV) as described above, depending on the non-aqueous electrolyte (non-aqueous electrolytic solution) that is used, the oxidative decomposition of the non-aqueous electrolyte is accelerated in a high voltage state, and acid (typically hydrogen fluoride (HF)) is generated in the electrolyte. In addition, the open-circuit voltage may also be regarded as an open potential. The generated acid becomes a cause of the elution of transition metal components in the positive active material, and there is concern that capacity deterioration may occur.

In Japanese Patent Application Publication No. 2014-103098 (JP 2014-103098 A), a non-aqueous electrolytic solution secondary battery which achieves a high open-circuit voltage that is equal to or higher than 4.3 V (vs.Li/Li⁺) by including phosphate or pyrophosphate having an alkali metal or a Group 2 element in a positive active material layer is described. An object of the technique described in JP 2014-103098 A is to suppress capacity deterioration caused by transition metal elution by allowing phosphate or pyrophosphate as an acid consuming material to react with an acid (typically the above-mentioned HF) generated in the non-aqueous electrolytic solution and thus suppressing transition metal elution from the positive active material.

According to the technique described in JP 2014-103098 A, an inorganic phosphate compound contained in the positive active material layer suppresses capacity deterioration caused by transition metal elution. However, when the content of the inorganic phosphate compound is too high, the influence of phosphate films is increased, and this may cause an increase in resistance. In accordance with this, capacity deterioration occurs. Therefore, there is a need to optimize the content of the inorganic phosphate compound, and the content of the inorganic phosphate compound with respect to the weight of the positive active material is specified in JP 2014-103098 A. However, most of the oxidative decomposition reactions of the electrolytic solution, which are the cause of metal elution, occur on the surface of the positive active material, and the amount of the acid being generated changes with the surface area of the active material. Accordingly, the optimal content varies according to the performance of the positive active material, and there may be cases where the optimal content cannot be specified on the basis of the weight of the positive active material.

### SUMMARY OF THE INVENTION

The present invention provides a lithium-ion secondary battery and a method of manufacturing the same.

A lithium-ion secondary battery according to a first aspect of the present invention includes a positive electrode, a negative electrode, and a non-aqueous electrolyte. The positive electrode includes a positive active material layer. The negative electrode includes a negative active material layer. The positive active material layer contains a positive active material and an inorganic phosphate compound. A BET specific surface area of the positive active material is 0.3 m²/g to 1.15 m²/g. The inorganic phosphate compound includes at least one of an alkali metal, an alkaline earth metal, and a hydrogen atom in a chemical formula. A content of the inorganic phosphate compound in the positive active material layer is 0.02 g/m² to 0.225 g/m² per unit surface area based on the BET specific surface area of the positive active material. The lithium-ion secondary battery is configured to allow an open-circuit voltage of the lithium-ion secondary battery to increase to 4.3 V or higher in terms of metal lithium.

In the specification, unless otherwise noted, a “BET specific surface area (specific surface area)” is a measurement value measured by a method that applies the BET theory in which an adsorption process is dynamically analyzed by expanding the Langmuir theory of localized single molecule adsorption. In this configuration, since the inorganic phosphate compound reacts with acid, the acid in the electrolyte can be consumed. Therefore, transition metal elution from the positive active material can be effectively suppressed, and capacity deterioration caused by the transition metal elution can be suppressed. Furthermore, since the content of the inorganic phosphate compound is optimized on the basis of the surface area of the positive active material, even in a case where a positive active material with different specifications is used, an increase in resistance due to phosphate films can be effectively suppressed. For this reason, according to the first aspect of the present invention, even in the lithium-ion secondary battery which is used at a voltage value (an open-circuit voltage of 4.3 V (vs.Li/Li⁺) or higher) which is higher than a general voltage value, the capacity deterioration caused by the transition metal elution from the positive active material and an increase in the resistance caused by the phosphate films can be compatibly suppressed. Therefore, the lithium-ion secondary battery having a high output and good cycle characteristics can be obtained.

In the first aspect of the present invention, the content of the inorganic phosphate compound in the positive active material layer may be 0.03 g/m² to 0.17 g/m² per unit surface area based on the BET specific surface area of the positive active material.

In the above configuration, the content of the inorganic phosphate compound in the positive active material layer may be 0.04 g/m² to 0.1 g/m² per unit surface area based on the BET specific surface area of the positive active material.

In the first aspect of the present invention, the inorganic phosphate compound may include a lithium phosphate.

Since the inorganic phosphate compound has high withstand voltage properties, the inorganic phosphate compound stably functions as an acid consuming material even at the open voltage of the lithium-ion secondary battery according to the first aspect of the present invention. Therefore, even in the lithium-ion secondary battery (with an open-circuit voltage of 4.3 V (vs.Li/Li⁺) or higher) as in the first aspect of the present invention, the capacity deterioration caused by the transition metal elution from the positive active material and an increase in the resistance caused by the phosphate films can be compatibly suppressed. In this specification, “lithium phosphate” means “phosphoric salt containing lithium,” but is not limited to Li₃PO₄.

In the above configuration, the lithium phosphate may include Li₃PO₄.

In the first aspect of the present invention, the positive active material may be a spinel positive active material containing Li, Ni, and Mn.

The spinel positive active material has high thermostability and high electrical conductivity. Therefore, the spinel positive active material can enhance the battery performance and durability of the lithium-ion secondary battery.

In the above configuration, the spinel positive active material may be LiNi_{0.5}Mn_{1.5}O₄.

In the first aspect of the present invention, the BET specific surface area of the positive active material may be 0.66 m²/g or higher.

As the surface area of the active material which is a reaction field of charge carriers is increased, output performance is enhanced. Since the lithium-ion secondary battery having the above configuration has the active material with a large surface area, a high output can be provided.

A second aspect of the invention is a method of manufacturing a lithium-ion secondary battery that includes a positive electrode, a negative electrode, and a non-aqueous electrolyte, the positive electrode including a positive active material layer containing a positive active material, and the negative electrode including a negative active material layer containing a negative active material. The method includes: obtaining a BET specific surface area of the positive active material; and adding an inorganic phosphate compound to the positive active material layer to adjust an amount of the inorganic phosphate compound to 0.02 g/m² to 0.225 g/m² per unit surface area based on the BET specific surface area of the positive active material. The inorganic phosphate compound includes at least one of an alkali metal, an alkaline earth metal, and a hydrogen atom. The lithium-ion secondary battery is configured to allow an open-circuit voltage of the lithium-ion secondary battery to increase to 4.3 V or higher in terms of metal lithium.

According to the manufacturing method, while the inorganic phosphate compound is contained as an acid consuming material, the content thereof is optimized with respect to the specific surface area of the positive active material. Therefore, the capacity deterioration caused by the transition metal elution from the positive active material and an increase in the resistance caused by the phosphate films can be compatibly suppressed. Therefore, the lithium-ion secondary battery having a high output and good cycle characteristics can be manufactured.

In the second aspect of the present invention, the amount of the inorganic phosphate, which is added to the positive active material layer, may be 0.03 g/m² to 0.17 g/m² per unit surface area based on the BET specific surface area of the positive active material.

In the above configuration, the amount of the inorganic phosphate, which is added to the positive active material layer, may be 0.04 g/m² to 0.1 g/m² per unit surface area based on the BET specific surface area of the positive active material.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view schematically illustrating the external appearance of a lithium-ion secondary battery according to an embodiment of the present invention;

FIG. 2 is a longitudinal sectional view schematically illustrating a sectional structure taken along line II-II of FIG. 1;

FIG. 3 is a manufacturing process diagram illustrating an example of a manufacturing process of the lithium-ion secondary battery according to the embodiment of the present invention;

FIG. 4 shows a graph of the relationship between the content ratio of lithium phosphate with respect to the weight of a positive active material and a capacity retention ratio; and

FIG. 5 shows a graph of the relationship between the content of lithium phosphate with respect to unit surface area (1 m²) based on the BET specific surface area of the positive active material and the capacity retention ratio.

### DETAILED DESCRIPTION OF EMBODIMENTS

Hereinafter, embodiments of the present invention will be described. Items which are not items that are particularly mentioned in the specification and are necessary items for the implementation of the present invention can be recognized as design items by those skilled in the related art in the corresponding field. The present invention can be implemented on the basis of the contents disclosed in the specification and general technical knowledge in the corresponding field. In the following drawings, like members and sites having the same actions are denoted by like reference numerals, and an overlapping description may be omitted or simplified. In each of the drawings, the dimensional relationships (length, width, thickness, and the like) do not necessarily reflect actual dimensional relationships.

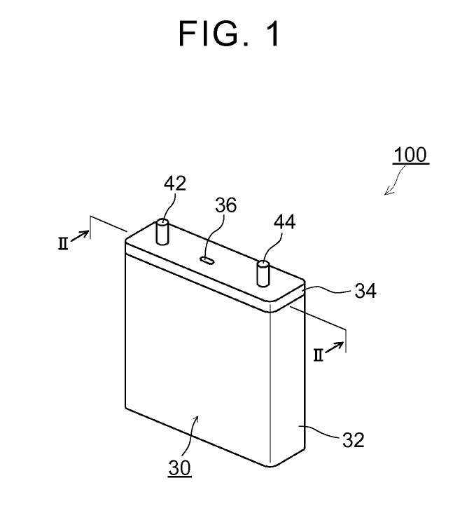

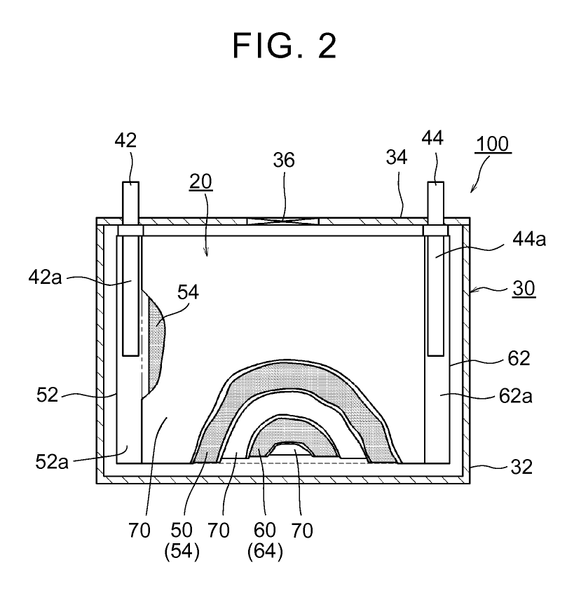

FIG. 1 is a view illustrating the external appearance of a lithium-ion secondary battery 100 according to an embodiment of the present invention. FIG. 2 is a sectional view schematically illustrating the internal configuration of a battery case 30 according to this embodiment.

As illustrated in FIGS. 1 and 2, the lithium-ion secondary battery 100 according to this embodiment is a so-called square battery. The lithium-ion secondary battery 100 is configured by storing a flat wound electrode assembly 20 and a non-aqueous electrolyte (not illustrated) in a battery case (that is, an exterior container) 30 having a flat square shape. The battery case 30 is configured to include a case body 32 having a box shape (that is, a rectangular parallelepiped shape with a bottom) in which one end (corresponding to an upper end portion in a typical use state of the lithium-ion secondary battery 100) thereof has an opening, and a cover 34 which seals the opening of the case body 32. As the material of the battery case 30, for example, a metal material which is lightweight and has good thermal conductivity, such as aluminum, stainless steel, and nickel-coated steel, is preferably used.

As illustrated in FIGS. 1 and 2, the cover 34 is provided with a positive electrode terminal 42 and a negative electrode terminal 44 for external connection, a thin safety valve 36 which is set to release the internal pressure of the battery case 30 in a case where the internal pressure increases to a predetermined level or higher, and an injection port (not illustrated) for injecting the non-aqueous electrolyte (non-aqueous electrolytic solution). The battery case 30 of the lithium-ion secondary battery 100 may have not only the square shape (box shape) as illustrated but also another well-known shape. For example, another shape includes a coin shape, a laminated shape, and the like, and a case shape may be appropriately selected therefrom.

As illustrated in FIG. 2, the wound electrode assembly 20 stored in the battery case 30 is made by winding, in the longitudinal direction, a laminate in which a positive electrode 50 having a positive active material layer 54 formed along the longitudinal direction of one surface or both surfaces (here, both surfaces) of a long positive electrode collector 52 and a negative electrode 60 having a negative active material layer 64 formed along the longitudinal direction of one surface or both surfaces (here, both surfaces) of a long negative electrode collector 62 are laminated via two sheets of long separators 70, and forming the laminate in a flat shape. The wound electrode assembly 20 is formed in the flat shape, for example, by pressing and crushing the wound assembly made by winding the laminate from a side direction. The positive electrode collector 52 included in the positive electrode 50 is made of an aluminum foil or the like. The negative electrode collector 62 included in the negative electrode 60 is made of a copper foil or the like.

As illustrated in FIG. 2, the center portion of the wound electrode assembly 20 in the winding axis direction thereof is provided with a wound core portion (that is, a lamination structure in which the positive active material layer 54 of the positive electrode 50, the negative active material layer 64 of the negative electrode 60, and the separator 70 are laminated). In addition, portions of a positive active material layer non-formation portion 52a and a negative active material layer non-formation portion 62a respectively extend from both end portions of the wound electrode assembly 20 in the winding axis direction in an outward direction from the wound core portion. A positive electrode collector plate 42a and a negative electrode collector plate 44a are respectively attached to a positive electrode side extension portion (the positive active material layer non-formation portion 52a) and a negative electrode side extension portion (the negative active material layer non-formation portion 62a) to be electrically connected to the positive electrode terminal 42 and the negative electrode terminal 44, respectively.

The positive active material layer 54 according to this embodiment contains a positive active material as the primary constituent element and an inorganic phosphate compound. As the positive active material, one type or two or more types of materials hitherto used for the lithium-ion secondary battery 100 may be used without particular limitations. For example, oxides (lithium transition metal composite oxides) containing lithium and transition metal elements as constituent metals, such as lithium nickel composite oxide (LiNiO₂ or the like), lithium cobalt composite oxide (LiCoO₂ or the like), and lithium manganese composite oxide (LiMn₂O₄ or the like), and phosphates containing lithium and transition metal elements as constituent metal elements, such as lithium manganese phosphate (LiMnPO₄) and lithium iron phosphate (LiFePO₄) may be employed. As a spinel positive active material, for example, lithium manganese composite oxide having a spinel structure expressed by a general formula of LiₚMn_{2-q}M_{q}O_{4+α} may be appropriately employed. Here, p is 0.9≦p≦1.2, q is 0≦q≦2, and typically 0≦q≦1 (for example, 0.2≦q≦0.6), and cc is a value determined to satisfy charge neutrality conditions in a range of −0.2≦α≦0.2. In a case where q is greater than 0 (0<q), M is one type or two or more types selected from arbitrary metal elements except for Mn or non-metallic elements. More specifically, M may be Na, Mg, Ca, Sr, Ti, Zr, V, Nb, Cr, Mo, Fe, Co, Rh, Ni, Pd, Pt, Cu, Zn, B, Al, Ga, In, Sn, La, W, Ce, or the like. Among these, at least one type of transition metal elements of Fe, Co, and Ni may be preferably employed. Specific examples thereof include LiMn₂O₄ and LiCrMnO₄. Among these, a spinel positive active material having Li, Ni, and Mn as the essential elements is preferable. More specifically, lithium nickel manganese composite oxide having a spinel structure expressed by a general formula of Liₓ(Ni_{y}Mn_{2-y-z}Ml_{z})O_{4+β} may be employed. Here, Ml may not be present or may be an arbitrary transition element except for Ni and Mn or a typical metal element (for example, one or two or more selected from Fe, Co, Cu, Cr, Zn and Al). Among these, Ml preferably includes at least one of trivalent iron and Co. Otherwise, Ml may also be a metalloid element (for example, one or two or more selected from B, Si, and Ge) or a non-metallic element. In addition, x is 0.9≦x≦1.2, y is 0<y, z is 0≦z, y+z<2 (typically y+z≦1), and β is obtained similarly to cc. In a preferable embodiment, y is 0.2≦y≦1.0 (more preferably 0.4≦y≦0.6, for example, 0.45≦y≦0.55), z is 0≦z<1.0 (for example, 0≦z≦0.3). As a particularly preferable specific example, LiNi_{0.5}Mn_{1.5}O₄ or the like may be employed. Such a positive active material can become a high-potential positive active material capable of realizing an open-circuit voltage (OCV) of equal to or higher than 4.3 V in terms of metal lithium (vs.Li/Li⁺) and is thus an appropriate positive active material for the implementation of the present invention. Furthermore, the spinel positive active material (LiNi_{0.5}Mn_{1.5}O₄ or the like) has high thermostability and high electrical conductivity and thus can be more preferably used in terms of battery performance and durability.

The positive active material is not particularly limited, and for example, a lithium transition metal composite oxide powder substantially formed of secondary particles having a cumulative 50% point of diameter (median diameter (D50)) in a range of 1 μm to 25 μm (typically 2 μm to 10 for example, 6 μm to 10 μm) in a volume-based particle size distribution obtained by a general laser diffraction particle size distribution measurement device is preferably used as the positive active material. In the specification, unless otherwise noted, a “particle size” means a median diameter in a volume-based particle size distribution that can be obtained by a general laser diffraction particle size distribution measurement device.

In addition, the positive active material used to form the positive active material layer 54 appropriately has a BET specific surface area of about 0.3 m²/g or greater, and preferably has a BET specific surface area of at least 0.66 m²/g (for example, 0.66 m²/g or greater and 2 m²/g or lower (for example, 1.15 m²/g or lower)). As the surface area of the active material which is a reaction field of charge carriers is increased, output performance is enhanced. Therefore, the positive active material formed as described above has a large surface area, and thus a high output of the lithium-ion secondary battery is realized.

The positive active material layer 54 may include components other than the positive active material which is the primary component described above, for example, a conductive material and a binder. As the conductive material, a carbon material such as carbon black including acetylene black (AB) and other materials (graphite or the like) may be appropriately used. As the binder, polyvinylidene fluoride (PVdF) or the like may be used.

In addition, the lithium-ion secondary battery disclosed herein includes the inorganic phosphate compound in the positive active material layer. The inorganic phosphate compound may be expressed in the chemical formula as a compound that includes one or more of an alkali metal, an alkaline earth metal, and a hydrogen atom. As the alkali metal element and the alkaline earth, one or more metals selected from the group consisting of lithium (Li), sodium (Na), potassium (K), magnesium (Mg), and calcium (Ca) are preferable. Examples of the inorganic phosphate compound include orthophosphoric acid (H₃PO₄) and pyrophosphate (H₄P₂O₇), or salts thereof. For example, sodium salt (Na₂P₄O₇), potassium salt (K₄P₂O₇), or the like may be employed. Typically, various inorganic phosphates, for example, (NH₄)₃PO₄, (NH₄)₂HPO₄, (NH₄)H₂PO₄, (NH₄)M₂PO₄, (NH₄)MPO₄, M₂HPO₄, MH₂PO₄, M₃PO₄, M₃(PO₄)₂, M₄P₂O₇, and M₂P₂O₇ (M in these formulas is an alkali metal or an alkaline earth metal such as Li, Na, K, Mg, or Ca) may be employed. Among these, lithium phosphate which contains lithium is preferable. Particularly, Li₃PO₄ is preferable.

The inorganic phosphate compound (typically the inorganic phosphates described above) has high withstand voltage properties and stably functions as an acid consuming material even at the open voltage of the lithium-ion secondary battery 100 of this embodiment. Therefore, capacity deterioration caused by the transition metal elution from the positive active material and an increase in the resistance caused by the phosphate films can be compatibly suppressed.

The content (addition amount) of the inorganic phosphate compound in the positive active material layer is preferably 0.02 g/m² to 0.225 g/m² per unit surface area (1 m²) based on the BET specific surface area of the high-potential positive active material contained in the positive active material layer. More preferably, the content thereof is 0.04 g/m² to 0.1 g/m². According to this mixing ratio, as well as the capacity deterioration caused by the transition metal elution from the positive active material, an increase in the battery resistance caused by the addition of the inorganic phosphate compound components can be suppressed. The state of the inorganic phosphate compound being present in the positive active material layer is not particularly limited, and the inorganic phosphate compound may be in a state of coating (adhering to) the positive active material (particles) or may also be in a state of being dispersed in the positive active material layer instead of adhering to the positive active material (particles). The inorganic phosphate compound is preferably present in a state of being substantially homogeneously dispersed in the positive active material layer. In this configuration, the elution of the transition metal components can be suppressed over the entire positive active material layer 54.

The negative active material layer 64 contains at least the negative active material. As the negative active material, for example, a carbon material such as graphite, hard carbon, or soft carbon may be used. The negative active material layer 64 may include components other than the active material, for example, a binder and a thickener. As the binder, styrene-butadiene rubber (SBR) or the like may be used. As the thickener, for example, carboxymethyl cellulose (CMC) or the like may be used.

As the separator 70, for example, a porous sheet (film) made of a resin such as polyethylene (PE), polypropylene (PP), polyester, cellulose, or polyamide may be employed. The porous sheet may have a single-layer structure, or may have a layered structure of two or more layers (for example, a three-layer structure in which PE layers are laminated on both surfaces of a PP layer).

As the non-aqueous electrolyte, typically, an electrolyte in which a predetermined support salt and an additive are contained in an organic solution (non-aqueous solvent) may be used.

As the non-aqueous solvent, various types of organic solvents that are used for the electrolyte of a general lithium-ion secondary battery 100, such as carbonates, ethers, esters, nitriles, sulfones, and lactones may be used without particular limitations. Specific examples thereof include ethylene carbonate (EC), propylene carbonate (PC), diethyl carbonate (DEC), dimethyl carbonate (DMC), and ethyl methyl carbonate (EMC). The non-aqueous solvents may be used singly or in an appropriate combination of two or more types thereof. Otherwise, a fluorine-based solvent such as fluorinated carbonates including monofluoroethylene carbonate (MFEC), difluoroethylene carbonate (DFEC), and trifluorinated dimethyl carbonate (TFDMC) may be preferably used. For example, a mixed solvent containing MFEC and TFDMC at a volume ratio of 1:2 to 2:1 (for example, 1:1) has high oxidation resistance and may be appropriately used in combination with a high-potential electrode.

As the support salt, for example, lithium salts such as LiPF₆, LiBF₄, and LiClO₄ may be appropriately used. As a particularly preferable support salt, LiPF₆ is employed. The concentration of the support salt is preferably 0.7 mol/L or higher and 1.3 mol/L or lower and is particularly preferably about 1.0 mol/L.

The non-aqueous electrolyte may further contain components other than the non-aqueous solvent and support salt as long as the effects of the present invention are not significantly damaged. Such arbitrary components may be used, for example, for one or two more purposes such as the enhancement of the output performance of the lithium-ion secondary battery 100, the enhancement of storage stability (the suppression of a reduction in capacity during storage), the enhancement of initial charge and discharge efficiency, and the like. Examples of the arbitrary components include various types of additives such as a gas generating agent including biphenyl (BP) and cyclohexylbenzene (CHB), a film forming agent including an oxalate complex compound containing a boron atom and/or a phosphorus atom, vinylene carbonate (VC), and fluoroethylene carbonate (FEC), a dispersant, and a thickener.

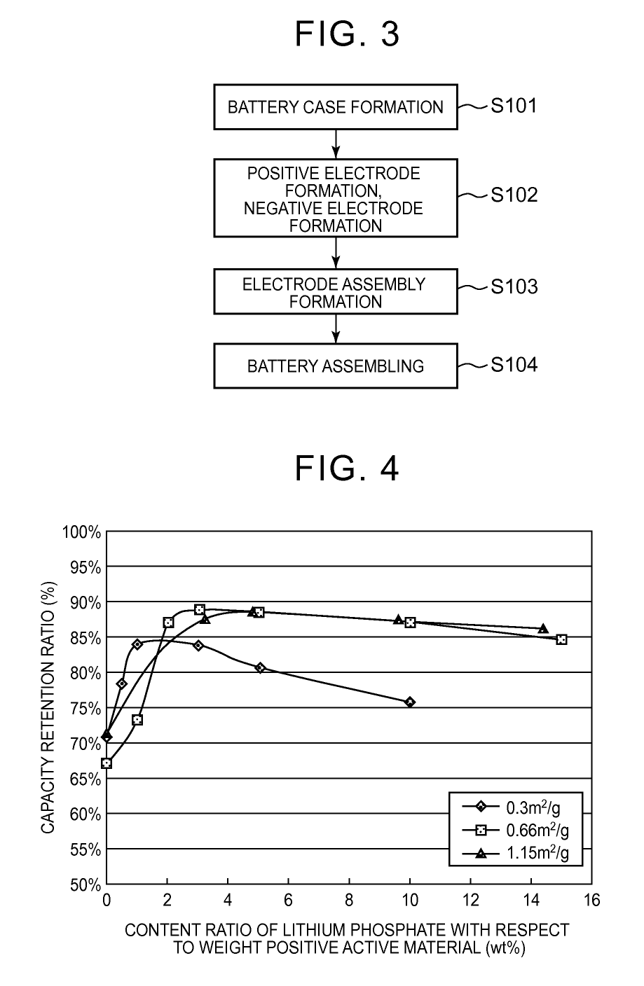

Next, a method of manufacturing the lithium-ion secondary battery 100 of the embodiment will be described. FIG. 3 is a manufacturing process diagram illustrating an example of a rough manufacturing process of the lithium-ion secondary battery 100 of the embodiment. The manufacturing of the lithium-ion secondary battery 100 is started from a manufacturing process S101 in which the battery case 30 is prepared.

Next, the positive electrode 50 and the negative electrode 60 included in the electrode assembly are prepared (manufacturing process S102). The manufacturing process S102 is described below in detail.

First, the positive electrode 50 is described. A paste-like (slurry-like) composition is prepared by dispersing the positive active material described above (for example, LiNi_{0.5}Mn_{1.5}O₄ which is a high-potential positive active material), the inorganic phosphate compound, and other materials (a binder, a conductive material, and the like) used as necessary in an appropriate solvent. In a case where PVdF is used as the binder, N-Methyl-2-pyrrolidone (NMP) is preferable as the solvent. The inorganic phosphate compound is a compound that contains one or more of an alkali metal, an alkaline earth metal, and a hydrogen atom in the chemical formula. More preferably, the inorganic phosphate compound is a compound that contains at least one type of lithium phosphates (typically, Li₃PO₄). Here, the BET specific surface area of the positive active material is obtained, and the inorganic phosphate compound is added to the positive active material so that the content of the inorganic phosphate compound reaches 0.02 g/m² to 0.225 g/m² (preferably, 0.04 g/m² to 0.1 g/m²) per unit surface area (1 m²) based on the BET specific surface area. Next, after applying an appropriate amount of the composition to the surface of the positive electrode collector 52, the solvent is removed by drying so as to allow the positive active material layer 54 having desired properties to be applied onto the positive electrode collector 52, thereby forming the positive electrode 50. In addition, by appropriately performing a pressing process as necessary, the properties (for example, average thickness, active material density, and the porosity of the active material layer) of the positive active material layer 54 can be controlled.

Next, the negative electrode 60 is described. For example, the negative electrode 60 may be manufactured in the same manner as the case of the positive electrode 50 described above. That is, a paste-like (slurry-like) composition is prepared by dispersing the negative active material and materials that are used as necessary in an appropriate solvent (for example, ion-exchange water), an appropriate amount of the composition is applied to the surface of the negative electrode collector 62, and thereafter the solvent is removed by drying, thereby forming the negative electrode. In addition, by appropriately performing a pressing process as necessary, the properties (for example, average thickness, active material density, and the porosity of the active material layer) of the negative active material layer 64 can be controlled.

After the positive electrode 50 and the negative electrode 60 are formed (the manufacturing process S102), an electrode assembly is formed (manufacturing process S103). Here, the electrode assembly is formed by using the above-described positive electrode 50, the negative electrode 60, and the separator 70. For example, the positive electrode 50 and the negative electrode 60 are laminated and wound via the separator 70. By doing so, the wound electrode assembly 20 is formed.

After forming the electrode assembly (the manufacturing process S103), the lithium-ion secondary battery 100 is assembled (manufacturing process S104). In the manufacturing process S104, the wound electrode assembly 20 is stored in the battery case 30, the non-aqueous electrolyte is injected thereinto, and the battery case 30 is sealed with the cover, thereby constructing the lithium-ion secondary battery 100.

According to the method of manufacturing the lithium-ion secondary battery 100 of the embodiment described above, the content of the inorganic phosphate compound is optimized. Therefore, the lithium-ion secondary battery 100 capable of suppressing the capacity deterioration caused by the transition metal elution and suppressing an increase in the resistance caused by the phosphate films can be manufactured. That is, it is possible to provide the lithium-ion secondary battery 100 having a high output and good cycle characteristics.

In the method of manufacturing the lithium-ion secondary battery 100 of the embodiment, the electrode assembly is formed after the battery case is formed. The embodiment of the present invention is not limited thereto, and the battery case may also be formed after forming the electrode assembly. That is, the manufacturing process S102 and the manufacturing process S103 may be performed before the manufacturing process S101.

The lithium-ion secondary battery 100 disclosed herein can be used for various purposes, and for example, may be appropriately used as a drive power source mounted on a vehicle such as a plug-in hybrid vehicle (PHV), a hybrid vehicle (HV), and an electric vehicle (EV).

Hereinafter, test examples regarding the present invention are described, but are not intended to limit the present invention to the test examples. In the following description, Samples 1 to 3, 7 to 10, and 14 to 17 correspond to Examples of the present invention. In addition, Samples 4 to 6, 11 to 13, and 18 correspond to Comparative Examples of the present invention.

Hereinafter, a laminated cell type battery of Sample 1 will be described. As a positive electrode mixed material, a spinel positive active material in which lithium phosphate (Li₃PO₄) is mixed in advance, acetylene black (conductive material), and PVdF (binder) were mixed to have a weight ratio of 89:8:3, and a slurry-like composition was produced by using NMP as a solvent. The spinel positive active material used here was LiNi_{0.5}Mn_{1.5}O₄ having an average particle size of 13 μm and a BET specific surface area of 0.3 m²/g. In addition, Li₃PO₄ had a content ratio corresponding to 1 wt % when the content of the positive active material (LiNi_{0.5}Mn_{1.5}O₄) was 100, and had a content corresponding to 0.033 g/m² per unit surface area (1 m²) based on the BET specific surface area of the positive active material. The positive electrode mixed material slurry was applied to an aluminum foil (positive electrode collector) having a thickness of 15 μm and was thereafter dried to form a positive active material layer, and the resultant was subjected to roll pressing, thereby producing a positive electrode. The positive electrode was cut into a square shape of 5 cm×5 cm in which a strip-shaped portion having a width of 10 mm protruded from one corner. The active material layer was removed from the strip-shaped portion to expose the aluminum foil and form a terminal portion such that the positive electrode with the terminal portion was obtained.

As a negative electrode mixed material, graphite (a negative active material having an average particle size of 20 μm and a graphitization degree of 0.9), CMC (thickener), and SBR (binder) were mixed to have a weight ratio of 98:1:1, and a slurry was produced by using water as a solvent. The negative electrode mixed material slurry was applied to a copper foil (negative electrode collector) having a thickness of 10 μm and was thereafter dried to form a negative active material layer, and the resultant was subjected to roll pressing, thereby producing a negative electrode. By processing the negative electrode into the same area and shape as those of the positive electrode with the terminal portion, the negative electrode with a terminal portion was obtained.

A non-aqueous electrolyte was prepared by dissolving LiPF₆ to have a concentration of 1 mol/L in a mixed solvent containing MFEC and TFDMC at a volume ratio of 1:1.

The positive electrode with the terminal portion and the negative electrode with the terminal portion were laminated via a separator (a porous three-layer sheet of PE/PP/PE) which was cut into an appropriate size and was impregnated with the non-aqueous electrolyte, and were covered with a laminate film. The non-aqueous electrolyte was further injected thereinto, and the film was sealed, thereby constructing a laminated cell type battery.

In the same manner as in Sample 1 described above, except that Li₃PO₄ had a content ratio corresponding to 3 wt % when the content of the positive active material was 100 and had a content corresponding to 0.100 g/m² per unit surface area (1 m²) based on the BET specific surface area of the positive active material, a laminated cell type battery of Sample 2 was constructed.

In the same manner as in Sample 1 described above, except that Li₃PO₄ had a content ratio corresponding to 5 wt % when the content of the positive active material was 100 and had a content corresponding to 0.167 g/m² per unit surface area (1 m²) based on the BET specific surface area of the positive active material, a laminated cell type battery of Sample 3 was constructed.

In the same manner as in Sample 1 described above, except that lithium phosphate (Li₃PO₄) was not used, a laminated cell type battery of Sample 4 in which lithium phosphate was not contained in the positive active material layer was constructed.

In the same manner as in Sample 1 described above, except that Li₃PO₄ had a content ratio corresponding to 0.5 wt % when the content of the positive active material was 100 and had a content corresponding to 0.017 g/m² per unit surface area (1 m²) based on the BET specific surface area of the positive active material, a laminated cell type battery of Sample 5 was constructed.

In the same manner as in Sample 1 described above, except that Li₃PO₄ had a content ratio corresponding to 10 wt % when the content of the positive active material was 100 and had a content corresponding to 0.333 g/m² per unit surface area (1 m²) based on the BET specific surface area of the positive active material, a laminated cell type battery of Sample 6 was constructed.

In the same manner as in Sample 1 described above, except that the specific surface area of the positive active material was 0.66 m²/g, Li₃PO₄ had a content ratio corresponding to 2 wt % when the content of the positive active material was 100 and had a content corresponding to 0.030 g/m² per unit surface area (1 m²) based on the BET specific surface area of the positive active material, a laminated cell type battery of Sample 7 was constructed.

In the same manner as in Sample 1 described above, except that the specific surface area of the positive active material was 0.66 m²/g, Li₃PO₄ had a content ratio corresponding to 3 wt % when the content of the positive active material was 100 and had a content corresponding to 0.045 g/m² per unit surface area (1 m²) based on the BET specific surface area of the positive active material, a laminated cell type battery of Sample 8 was constructed.

In the same manner as in Sample 1 described above, except that the specific surface area of the positive active material was 0.66 m²/g, Li₃PO₄ had a content ratio corresponding to 5 wt % when the content of the positive active material was 100 and had a content corresponding to 0.076 g/m² per unit surface area (1 m²) based on the BET specific surface area of the positive active material, a laminated cell type battery of Sample 9 was constructed.

In the same manner as in Sample 1 described above, except that the specific surface area of the positive active material was 0.66 m²/g, Li₃PO₄ had a content ratio corresponding to 10 wt % when the content of the positive active material was 100 and had a content corresponding to 0.152 g/m² per unit surface area (1 m²) based on the BET specific surface area of the positive active material, a laminated cell type battery of Sample 10 was constructed.

In the same manner as in Sample 1 described above, except that the specific surface area of the positive active material was 0.66 m²/g, and Li₃PO₄ was not used, a laminated cell type battery of Sample 11 in which Li₃PO₄ was not contained in the positive active material layer was constructed.

In the same manner as in Sample 1 described above, except that the specific surface area of the positive active material was 0.66 m²/g, Li₃PO₄ had a content ratio corresponding to 1 wt % when the content of the positive active material was 100 and had a content corresponding to 0.015 g/m² per unit surface area (1 m²) based on the BET specific surface area of the positive active material, a laminated cell type battery of Sample 12 was constructed.

In the same manner as in Sample 1 described above, except that the specific surface area of the positive active material was 0.66 m²/g, Li₃PO₄ had a content ratio corresponding to 15 wt % when the content of the positive active material was 100 and had a content corresponding to 0.227 g/m² per unit surface area (1 m²) based on the BET specific surface area of the positive active material, a laminated cell type battery of Sample 13 was constructed.

In the same manner as in Sample 1 described above, except that the specific surface area of the positive active material was 1.15 m²/g, Li₃PO₄ had a content ratio corresponding to 3.4 wt % when the content of the positive active material was 100 and had a content corresponding to 0.028 g/m² per unit surface area (1 m²) based on the BET specific surface area of the positive active material, a laminated cell type battery of Sample 14 was constructed.

In the same manner as in Sample 1 described above except, that the specific surface area of the positive active material was 1.15 m²/g, Li₃PO₄ had a content ratio corresponding to 5.1 wt % when the content of the positive active material was 100 and had a content corresponding to 0.042 g/m² per unit surface area (1 m²) based on the BET specific surface area of the positive active material, a laminated cell type battery of Sample 15 was constructed.

In the same manner as in Sample 1 described above, except that the specific surface area of the positive active material was 1.15 m²/g, Li₃PO₄ had a content ratio corresponding to 10.2 wt % when the content of the positive active material was 100 and had a content corresponding to 0.083 g/m² per unit surface area (1 m²) based on the BET specific surface area of the positive active material, a laminated cell type battery of Sample 16 was constructed.

In the same manner as in Sample 1 described above, except that the specific surface area of the positive active material was 1.15 m²/g, Li₃PO₄ had a content ratio corresponding to 15.3 wt % when the content of the positive active material was 100 and had a content corresponding to 0.125 g/m² per unit surface area (1 m²) based on the BET specific surface area of the positive active material, a laminated cell type battery of Sample 17 was constructed.

In the same manner as in Sample 1 described above, except that the specific surface area of the positive active material was 1.15 m²/g, and Li₃PO₄ was not used, a laminated cell type battery of Sample 18 in which Li₃PO₄ was not contained in the positive active material layer was constructed.

Hereinafter, a conditioning treatment performed on the text examples will be described. Each of the battery cells of Samples 1 to 18 described above was interposed between two plates, and confined to a state under a load of 350 kgf (350 kg/25 cm²). Each confined battery cell was subjected to constant current charge to 4.9 V at a rate of 1/3 C, disconnected for 10 minutes, was thereafter subjected to constant current discharge to 3.5 V at a rate of 1/3 C, and then disconnected for 10 minutes. This operation was performed three times. The following measurement operations were performed on the battery cells in the confined state unless particularly noted.

After the conditioning treatment, a test (endurance test) in which an operation of performing constant current charge to 4.9 V at a rate of 2 C in an environment at a temperature of 60° C. and thereafter performing constant current discharge to 3.5 V at a rate of 2 C was repeated 200 times was conducted on the battery cell of each of Samples. Table 1 shows the capacity retention ratio (the ratio of the capacity after 200 cycles to the initial capacity) after the endurance test was conducted on each of Samples.

TABLE 1

| | | | Content of | |
|---|---|---|---|---|
| | | | lithium | |
| | | | phosphate with | |
| | | | respect to | |
| | | Content of | unit surface | |
| | Specific | lithium | area (1 m²) | |
| | surface | phosphate with | based on | |
| | area of | respect to | BET specific | |
| | positive | weight of | surface area | Capacity |
| | active | positive active | of positive | retention |
| | material | material | active material | ratio |
| Samples | (m²/g) | (wt %) | (g/m²) | (%) |
| 1 | 0.3 | 1 | 0.033 | 83.9 |
| 2 | 0.3 | 3 | 0.100 | 83.8 |
| 3 | 0.3 | 5 | 0.167 | 80.7 |
| 4 | 0.3 | 0 | 0 | 70.7 |
| 5 | 0.3 | 0.5 | 0.017 | 78.3 |
| 6 | 0.3 | 10 | 0.333 | 75.7 |
| 7 | 0.66 | 2 | 0.030 | 87.0 |
| 8 | 0.66 | 3 | 0.045 | 88.8 |
| 9 | 0.66 | 5 | 0.076 | 88.5 |
| 10 | 0.66 | 10 | 0.152 | 87.0 |
| 11 | 0.66 | 0 | 0 | 67.0 |
| 12 | 0.66 | 1 | 0.015 | 73.2 |
| 13 | 0.66 | 15 | 0.227 | 84.5 |
| 14 | 1.15 | 3.4 | 0.028 | 87.5 |
| 15 | 1.15 | 5.1 | 0.042 | 88.5 |
| 16 | 1.15 | 10.2 | 0.083 | 87.4 |
| 17 | 1.15 | 15.3 | 0.125 | 86.1 |
| 18 | 1.15 | 0 | 0 | 71.4 |

As shown in Table 1, it was recognized that compared to Samples 4, 11, and 18 in which Li₃PO₄ was not contained in the positive active material, the batteries in the other samples containing Li₃PO₄ had improved capacity retention ratio after the endurance test. It is thought that this is because Li₃PO₄ that is present in the positive active material layer captures acid generated from the non-aqueous electrolytic solution in a high-voltage state and suppresses the reaction between the positive active material and the acid and thus capacity deterioration caused by transition metal elution is suppressed. In addition, it was recognized that when the content of Li₃PO₄ was too high, the capacity retention ratio tended to decrease when a predetermined content was reached.

FIG. 4 shows a graph of the relationship between the content ratio of lithium phosphate with respect to the weight of the positive active material and the capacity retention ratio on the specific surface area of each of the positive active materials.

As shown in FIG. 4, when the content ratio with respect to the weight of the positive active material was plotted, it was recognized that the specific surface areas of three types of positive active materials were different from each other in the optimal value of the content ratio of lithium phosphate. Furthermore, it was recognized that as the specific surface area was increased, the optimal value of lithium phosphate tended to increase. It is thought that this is because the decomposition of the non-aqueous electrolytic solution and the generation of acid were accelerated as the surface area of the positive active material was increased, and thus the amount of lithium phosphate necessary for acid consumption was increased.

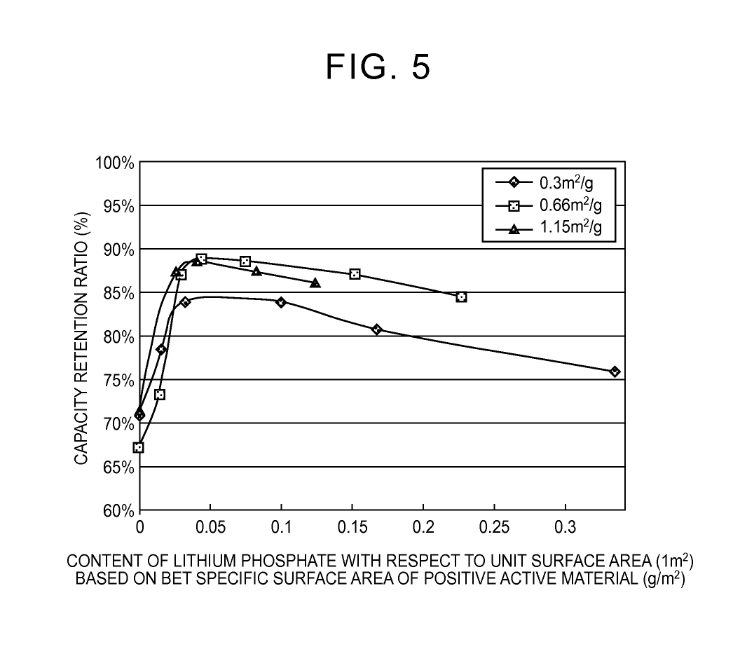

FIG. 5 shows a graph of the relationship between the content of lithium phosphate with respect to unit surface area (1 m²) based on the BET specific surface area of the positive active material and the capacity retention ratio.

As shown in FIG. 5, when the content with respect to the specific surface area was plotted, unlike FIG. 4 in which the content ratio with respect to the weight of the positive active material is plotted, even when different positive active materials were used, very similar optimal content ranges of lithium phosphate were recognized. From the results, by plotting the content with respect to the specific surface area, it is possible to specify the optimal content of lithium phosphate regardless of the specification of the positive active material. A specific content of lithium phosphate with respect to unit surface area (1 m²) based on the BET specific surface area of the positive active material is preferably 0.02 g/m² to 0.225 g/m² at which the capacity retention ratio is 80% or higher, and is particularly preferably 0.04 g/m² to 0.1 g/m². The capacity retention ratio when the specific surface area of the positive active material is 1.15 m²/g is always higher than that when the specific surface area of the positive active material is 0.3 m²/g. Therefore, it is apparent that the capacity retention ratio even when the content ratio of lithium phosphate with respect to the weight of the positive active material is 0.225 g/m² shows a high value.

While the present invention has been described in detail, the embodiments and Samples are merely examples, and various modifications and changes of the specific examples described above are included in the invention described herein.

What is claimed is:

1. A lithium-ion secondary battery comprising:
a positive electrode including a positive active material layer;
a negative electrode including a negative active material layer; and
a non-aqueous electrolyte, wherein
the positive active material layer contains a positive active material and an inorganic phosphate compound,
a BET specific surface area of the positive active material is 0.3 m²/g to 1.15 m²/g,
the inorganic phosphate compound includes at least one of an alkali metal, an alkaline earth metal, and a hydrogen atom in a chemical formula,
a content of the inorganic phosphate compound in the positive active material layer is 0.02 g/m² to 0.225 g/m² per unit surface area based on the BET specific surface area of the positive active material, and
the lithium-ion secondary battery is configured to allow an open-circuit voltage of the lithium-ion secondary battery to increase to 4.3 V or higher in terms of metal lithium.

2. The lithium-ion secondary battery according to claim 1, wherein
the content of the inorganic phosphate compound in the positive active material layer is 0.03 g/m² to 0.17 g/m² per unit surface area based on the BET specific surface area of the positive active material.

3. The lithium-ion secondary battery according to claim 2, wherein
the content of the inorganic phosphate compound in the positive active material layer is 0.04 g/m² to 0.1 g/m² per unit surface area based on the BET specific surface area of the positive active material.

4. The lithium-ion secondary battery according to claim 1, wherein
the inorganic phosphate compound includes at least one lithium phosphate.

5. The lithium-ion secondary battery according to claim 4, wherein
the lithium phosphate includes Li₃PO₄.

6. The lithium-ion secondary battery according to claim 1, wherein
the positive active material is a spinel positive active material containing Li, Ni, and Mn.

7. The lithium-ion secondary battery according to claim 6, wherein
the spinel positive active material is LiNi_{0.5}Mn_{1.5}O₄.

8. The lithium-ion secondary battery according to claim 1, wherein
the BET specific surface area of the positive active material is 0.66 m²/g or higher.

9. A method of manufacturing a lithium-ion secondary battery that includes a positive electrode, a negative electrode, and a non-aqueous electrolyte, the positive electrode including a positive active material layer containing a positive active material, and the negative electrode including a negative active material layer containing a negative active material,
the method comprising:
obtaining a BET specific surface area of the positive active material; and
adding an inorganic phosphate compound to the positive active material layer to adjust an amount of the inorganic phosphate compound to 0.02 g/m² to 0.225 g/m² per unit surface area based on the BET specific surface area of the positive active material, wherein
the inorganic phosphate compound includes at least one of an alkali metal, an alkaline earth metal, and a hydrogen atom, and
the lithium-ion secondary battery is configured to allow an open-circuit voltage of the lithium-ion secondary battery to increase to 4.3 V or higher in terms of metal lithium.

10. The method according to claim 9, wherein
the amount of the inorganic phosphate, which is added to the positive active material layer, is 0.03 g/m² to 0.17 g/m² per unit surface area based on the BET specific surface area of the positive active material.

11. The method according to claim 10, wherein
the amount of the inorganic phosphate, which is added to the positive active material layer, is 0.04 g/m² to 0.1 g/m² per unit surface area based on the BET specific surface area of the positive active material.
